(19) United States
(12) Patent Application Publication
(10) Pub. No.: US 2024/0332838 A1
(43) Pub. Date: Oct. 3, 2024

(54) BOARD CONNECTOR WITH AN IMPROVED METAL HOUSING AND AN IMPROVED METAL PLATE

(71) Applicants: FUDING PRECISION COMPONENTS (SHENZHEN) CO., LTD., Shenzhen (CN); FOXCONN INTERCONNECT TECHNOLOGY LIMITED, Grand Cayman (KY)

(72) Inventors: TENG HUANG, Shenzhen (CN); DE-JIN CHEN, Shenzhen (CN); SHIH-WEI HSIAO, New Taipei (TW); YU-SAN HSIAO, New Taipei (TW); HE CHEN, Zhengzhou (CN)

(21) Appl. No.: 18/612,090

(22) Filed: Mar. 21, 2024

(30) Foreign Application Priority Data
Mar. 30, 2023 (CN) 202320767110.5
Jun. 7, 2023 (CN) 202321442654.0

(51) Int. Cl. H01R 12/71; H01R 12/67; H01R 13/502

(52) U.S. Cl. CPC H01R 12/716; H01R 12/675; H01R 13/5025

(57) ABSTRACT

A board connector includes: a metal housing having a base portion, four mating tubes opening forward, and four receiving grooves opening through a rear face and a bottom face of the base portion and communicating with corresponding mating tubes; four terminal assemblies received and retained in corresponding receiving grooves; and a rear plate, wherein the base portion of the metal housing has a rear guiding slot and a supporting portion at each side wall thereof, the supporting portions extend horizontally, the rear plate slides into the rear guiding slots from the bottom face, and the supporting portions block a bottom face of the rear plate from moving downwardly.

### BACKGROUND OF THE INVENTION

### Field of the Invention

The present invention relates to an electrical connector.

### Description of Related Arts

U.S. Pat. No. 11,424,578 discloses an electrical connector for high-speed transmission which includes a housing formed by a base portion and a cover portion. The housing has at least one tunnel through which at least one electrical wire passes and a mating tube with a mating groove provided at a front end of the housing, at least one electrical wire going through the tunnel. The electrical wire in the tunnel is embedded in surrounding material with a relative dielectric constant less than 2. The mating tube is surrounded by a shielding cover which can be made of conductive metal materials, plastic materials, etc. A big mating space is formed between the mating tube and the shielding cover. However, there is some gap between the shielding cover and the metal housing as the shielding cover is fixed to the metal housing by clamping. So the waterproof performance of the connector is poor. In addition, the cover portion is assembled and attached to the base portion in a direction that is the same as the mating direction in which the connector and a mating connector are mated. So the cover portion has a risk of falling off from the base portion when the electrical connector and the mating connector are separated.

Therefore, it is desired to provide a board connector with improved structure.

### SUMMARY OF THE INVENTION

An object of the present invention is to provide a board connector with improved structure.

To achieve the above object, a board connector comprises: a metal housing comprising a base portion, a connecting portion extending forward from the base portion, and a mating portion extending forward from the connecting portion, the mating portion comprising at least one mating tube opening forward; at least one terminal assembly retained in the metal housing and comprising an insulating base and a contact retained in the insulating base with a contacting portion extending into the corresponding mating tube and a tail portion exposed to the insulating base; and an outer shell comprising a main portion fixed on the connecting portion and a circumferential wall extending forward from the main portion, the circumferential wall surrounding the mating portion to define a mating space therebetween, wherein the outer shell is fixed with the metal housing by an injection molding process, and the main portion of the outer sell has an annular rib filled in an annular slot at an outside of the connecting portion.

A board connector comprises: a metal housing comprising a base portion, four mating tubes opening forward, and four receiving grooves opening through a rear face and a bottom face of the base portion and communicating with corresponding mating tubes; four terminal assemblies received and retained in corresponding receiving grooves; and a rear plate, wherein the base portion of the metal housing has a rear guiding slot and a supporting portion at each side wall thereof, the supporting portions extend horizontally, the rear plate slides into the rear guiding slots from the bottom face, and the supporting portions block a bottom face of the rear plate from moving downwardly.

### BRIEF DESCRIPTION OF THE DRAWING

FIG. 1 is a front and top perspective view of a board connector in a first embodiment of this present invention;

FIG. 2 is a bottom and rear perspective view of the board connector of FIG. 1;

FIG. 3 is a cross-sectional view of the board connector along line A-A of FIG. 1;

FIG. 4 is an exploded perspective view of the board connector of FIG. 2;

FIG. 5 is another further exploded perspective view of the board connector of FIG. 4;

FIG. 6 is a front perspective view of four terminal assemblies of the board connector of FIG. 1; and

FIG. 7 is a rear perspective view of the four terminal assemblies of the board connector of FIG. 6;

FIG. 8 is an exploded perspective view of two terminal assemblies of the board connector of FIG. 6;

FIG. 9 is a front perspective view of a board connector of the second embodiment of this present invention;

FIG. 10 is a rear perspective view of the board connector of FIG. 9;

FIG. 11 is an exploded perspective view of the board connector of FIG. 10 with an enlarged part of the base portion;

FIG. 12 is an exploded perspective view of the board connector of FIG. 9;

FIG. 13 is another exploded perspective view of the board connector of FIG. 12;

FIG. 14 is a cross-sectional view of the board connector along line B-B of FIG. 10; and

FIG. 15 is a cross-sectional view of the board connector along line C-C of FIG. 10.

### DETAILED DESCRIPTION OF THE PREFERRED EMBODIMENT

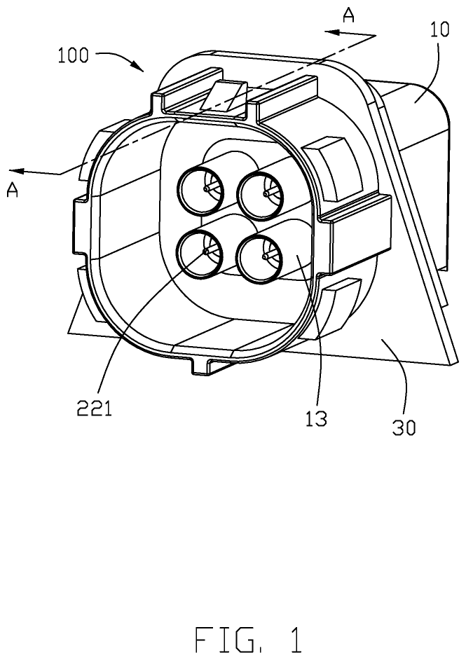

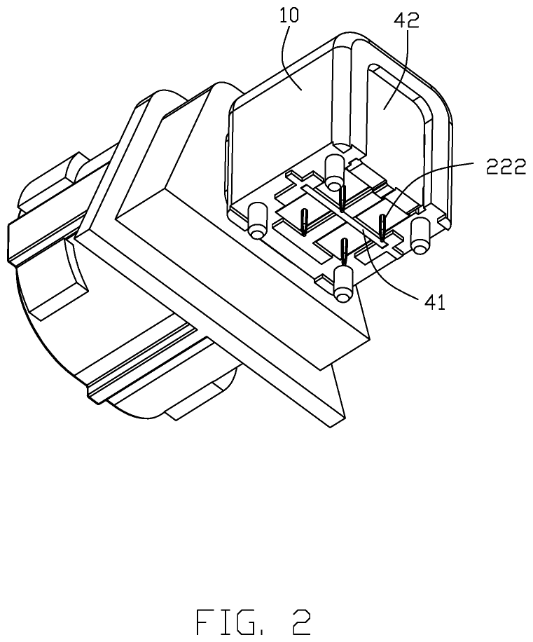

Referring to FIGS. 1-4, a board connector 100 adapted for high-speed signal transmission used in vehicles is illustrated, which comprises a metal housing 10, a terminal module 20, and an outer shell 30.

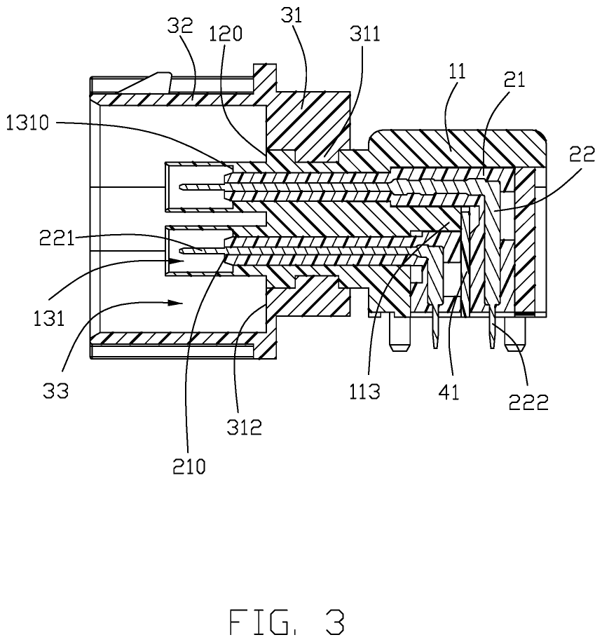

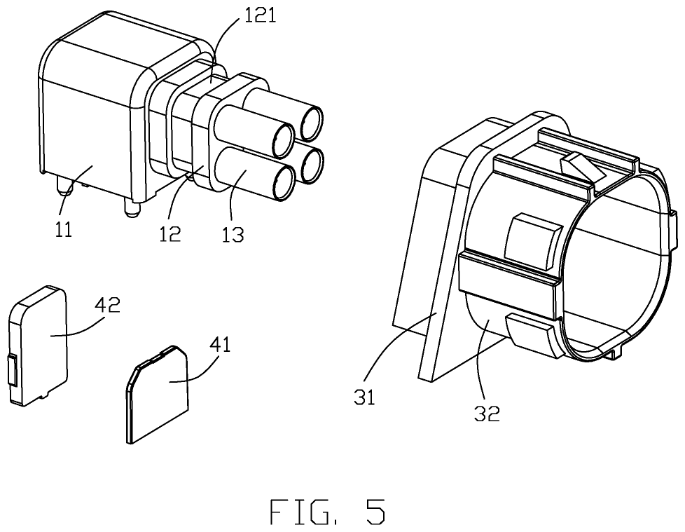

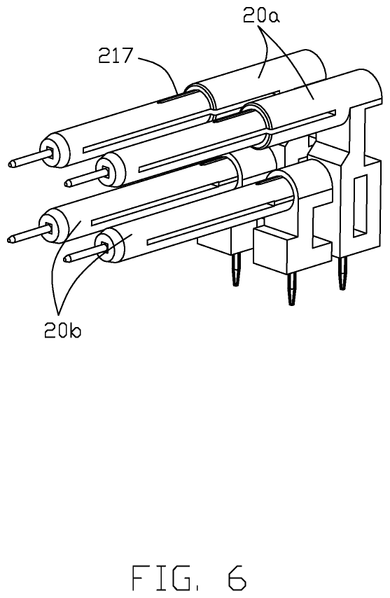

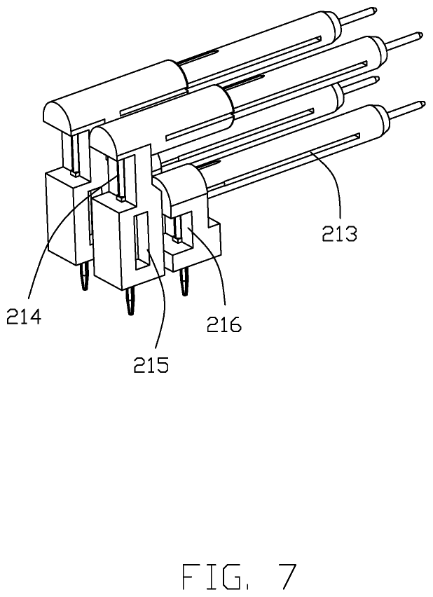

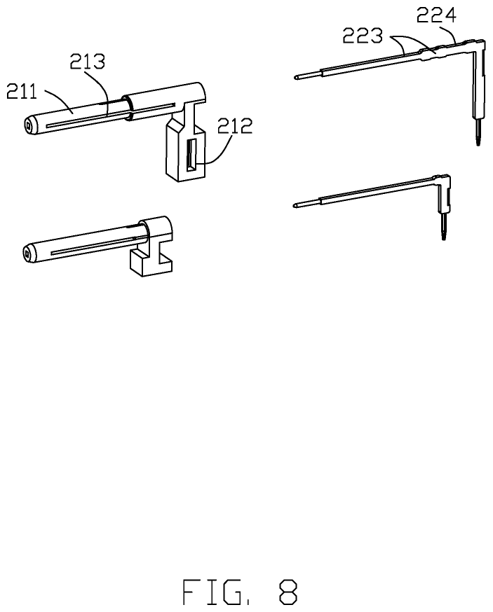

Referring to FIG. 3 and FIG. 5, the metal housing 10 comprises a base portion 11, a connecting portion 12 extending forward from the base portion 11, and a mating portion 13 extending forward from the connecting portion 12. The mating portion 13 has at least one mating tube 131 opening forward and the connecting portion 12 has an annular slot 121 at an outside thereof. The outer shell 30 has an upright main portion 31 and a circumferential wall 32 extending forward from main portion 31. The main portion 31 is fixed at the outside of the connecting portion 12, the circumferential wall 32 surrounds the mating portion 13, thereby defining a mating space 33 therebetween. The circumferential wall 32 extends past the front end of the mating portion 13. The outer shell 30 is integrally molded on the metal housing 10 by injection and the main portion 31 is formed with an annular rib 311 filled in the annular slot 121. Thus, the way that the outer shell 30 and the main body 10 are fixed not only ensures the coaxiality of the board connector 100, but also make the board connector 100 more waterproofed. Combing with FIGS. 6-8, four terminal assemblies 20 are retained in the metal housing 10, each terminal assembly 20 comprise an insulating base 21 and a contact 22 fixed in the insulating base 21 with a contacting portion 221 and a tail portion 222 exposed to the insulating base 21. The terminal assemblies 20 are retained and received in the metal housing 10, and the contacting portion 221 extends into and is exposed to the mating tube 131. A front face 312 of the main portion 31 exposed in the mating space 33 as shown in FIG. 3 is flush with a front face 120 of the connecting portion 12, thus, a resisting face is constructed, which can prevent the excessive insertion of a mating connector (not shown). A bottom wall 1310 of the mating tube 131 is in front of the front face 120 of the connecting portion 12, and a front face 210 of the insulating base 21 goes past the bottom wall 1310 a little.

Referring to FIGS. 5-8, the mating portion 13 has four mating tubes 131, four terminal assemblies 20 are inserted into the four mating tubes 131 one to one with two of them in the upper row, named upper terminal assemblies, and two of them in the lower row. Each insulating base 21 has a horizontal portion 211 and a vertical portion 212, and the insulating base 21 is fixed with the contact 22 by injection molding. Similar to the insulating base 21, the contact 22 has a horizontal portion and a vertical portion too. So the terminal assembly 20 also has a horizontal portion and a vertical portion. The contacting portion 221 and the tail portion 222 of the contact 22 are cylindrical, and a middle portion 223 connecting with the contacting portion 221 and the tail portion 222 is plate-like. Upper and lower edges of the middle portion 223 near the vertical portion thereof have a plural protrusions, so depressions 224 interleaved with the protrusions are formed, thus, the insulating base 21 can be filled in the depressions 224 when it is injection molded with the contact 22, making the terminal assembly 20 more secure and firm. The horizontal portion 211 is provided with a slot 213 in which the contact 22 is partially exposed. The vertical portion 212 of the insulating base 21 of the two terminal assemblies 20 in the upper row have rear notches 214 opening backward and side notches 216 opening sideward. The contacts 22 are partially exposed in the rear notches, making the high-frequency performance of the board connector 100 greatly improved. The horizontal portion 211 of the insulator housing 21 is provided with a convex rib 217 near the rear end thereof for increasing an interference force.

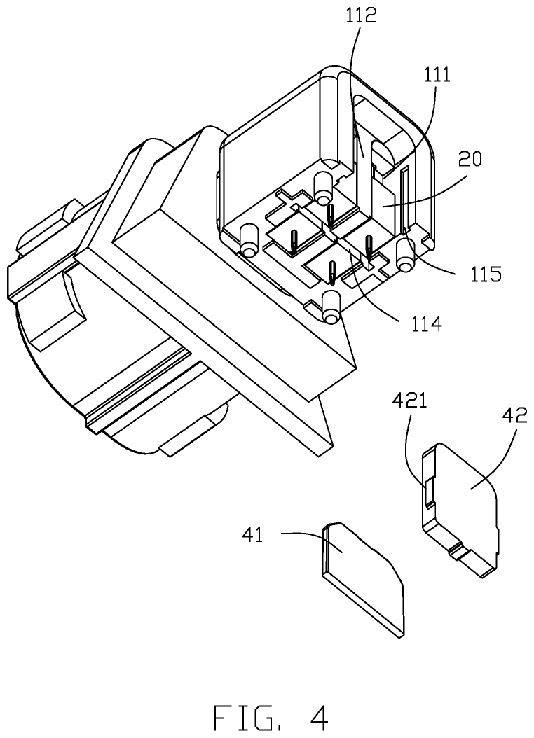

Referring to FIG. 4, the base portion 11 has a bottom face, a rear face and four receiving grooves 111. Each receiving groove 111 opens through the bottom face and the rear face of the base portion and extends forward, getting interconnected with the corresponding mating tube 131. The four receiving grooves 111 are separated by a vertical wall 112 and a horizontal wall 113. Preferably, the upper terminal assemblies and lower assemblies are separated by the horizontal wall 113 of the metal housing 10, and terminal assemblies located at the one side of the base portion 11, which is formed by a upper terminal assembly and a lower terminal assembly, are separated from that at another side of the base portion 11 by the vertical wall 112 of the metal housing 10. The four terminal assemblies 20 are inserted into the metal housing 10 from the rear of the base portion 11 until the contacting portions 221 of the four contacts 22 of the four terminal assemblies 20 go into the mating tube 131 and the tail portion 222 of the contact 22 extends out of the bottom face of the base portion 11.

Referring to FIG. 4, the base portion 11 has a middle guiding slot 114 or a first guiding slot and a rear guiding slot 115 or a second guiding slot at each side wall there of a first the rear of the vertical portions of the two terminal assemblies 20 in the lower row. The middle metal plate 41 is between the vertical portions of the terminal assemblies in the upper row and the lower row for separating them. A second metal plate 42 or a rear metal plate is inserted and retained in the rear guiding slot 115 and is at the rear of the vertical portions of the two terminal assemblies 20 in the upper row. As the vertical portions of the two terminal assemblies 20 in the upper row are behind that of the two terminal assemblies 20 in the lower row, so the rear metal plate 42 behind the vertical portions of the two terminal assemblies 20 in the upper row are also behind the vertical portions of the four terminal assemblies, which not only prevent the terminal assemblies 20 from falling out from the metal housing 10 due to environmental or other reasons, but also shield the terminal assemblies 20 together with the metal housing 10 to avoid signal interference. The depth of the middle guiding slot 114 is deeper than that of the rear guiding slot 115 at the side walls of the base portion 11. The rear metal plate 42 has two vertical side faces each of which has a guiding bump 421. Preferably, in this invention, a length of the guiding bump 421 in an upper-lower direction is less than that of the vertical side face and a width in a front-rear direction of the guiding bump 421 is less than that of the vertical side face too. The guiding bump 421 is near a rear face of the rear metal plate 42 and can slide into and be fixed in the rear guiding slot 115, thus, the front face of the rear metal plate 42 can tightly press forward against the vertical portions of terminal assemblies 20 in the upper row. The vertical wall 112 has a slot for the middle metal plate 41 to pass through. The second plate 42 is at the rear of the vertical wall 112.

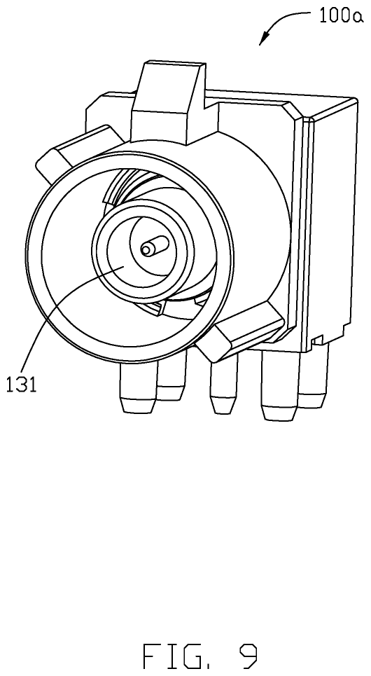

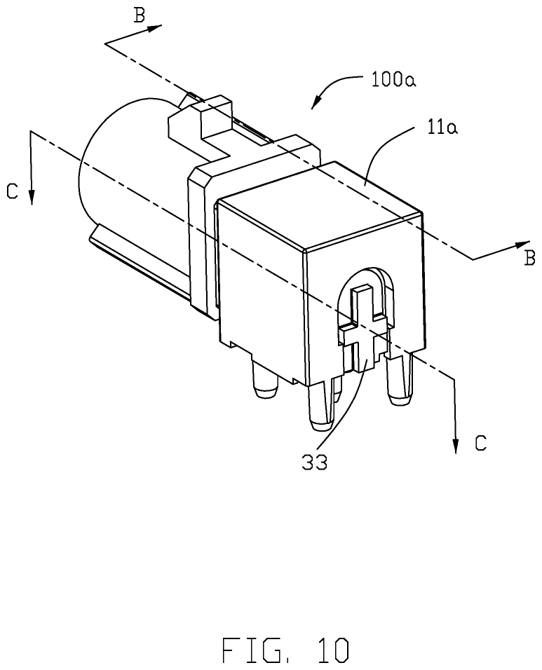

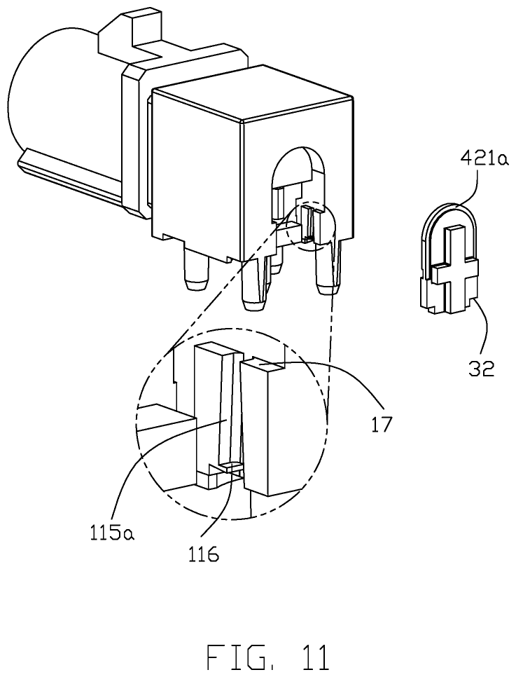

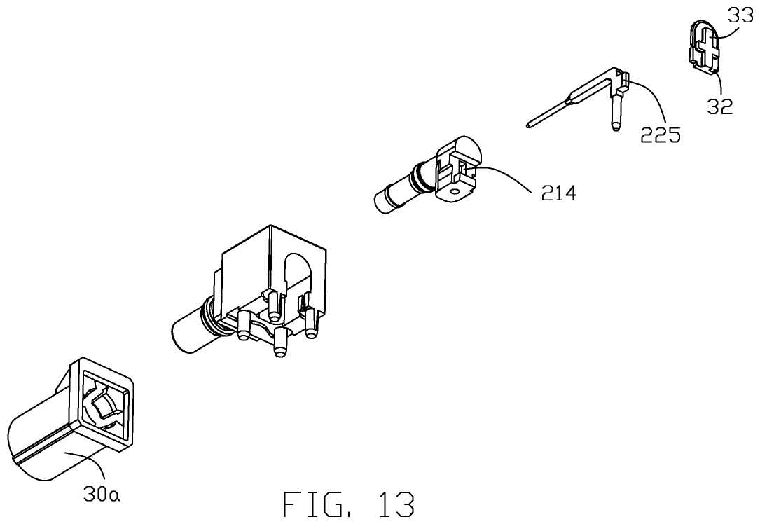

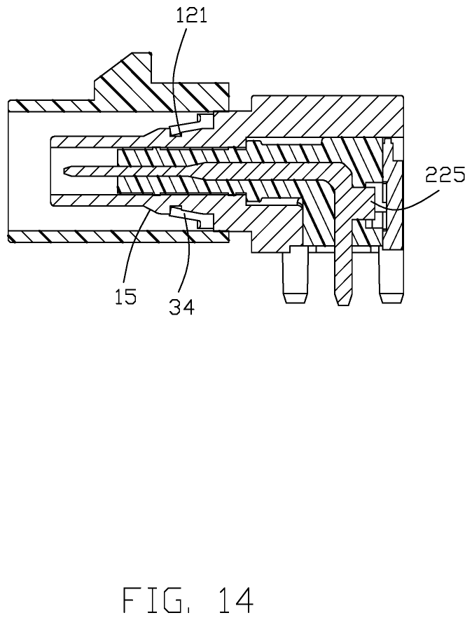

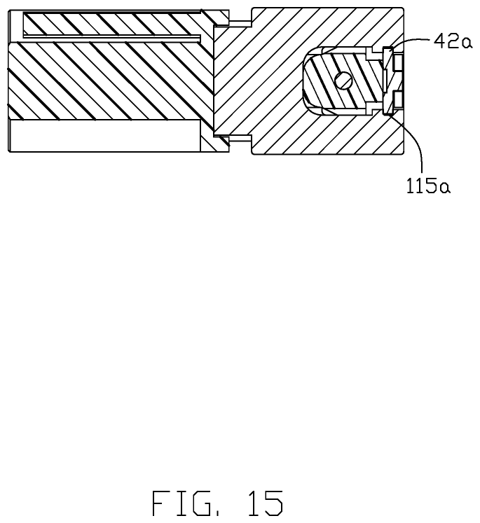

Referring to FIGS. 9-15, a second embodiment of the board connector 100a is illustrated. Only the feathers of the board connector that are different from that in the first embodiment will be introduced. The metal housing 10a has only one mating tube 131, and only one terminal assembly 20 is retained in the metal housing 10a. The rear plate 42a slides into the rear clapping slot 115a. The inside wall of the base portion lla is provided with a supporting portion 116 which supports a bottom face of rear plate 42a upwardly, for preventing the rear plate 42a from dropping down. Preferably, the rear plate 42a is made from a metal plate.

Referring to FIGS. 9-11, the side walls of the base portion 11a each has a limiting bump 17 respectively, the two limiting bumps face to each other, the rear guiding slot 115a goes through the limiting bump 17 in the upper-lower direction. The rear guiding slot 115a becomes more and more narrow from the lower end to the top end thereof. A lower end of the guiding bump 421a is with a certain distance over the bottom face of the rear plate 42a. The rear plate 42a has two notches 32 at two ends of the bottom face thereof. The supporting portion 116 is received in the notches 32 when the rear plate 42a is assembled to the base portion 11a. An opening of the receiving groove 111a on the rear face of the base portion 11a is roughly arched, and the rear plate 42a is roughly arched too. The guiding bump 421a is also roughly arched. Preferably, the rear plate 42a has an inverted U-shaped guiding bump which extends from one side to another side of the rear plate 42a. A rear face of the rear plate 42a has a cross-shaped protruding rib 33, which can prevent the rear plates 42a from overlapping during a barrel plating process. Firstly, assemble the rear plate 42a to the base portion 11 by sliding the guiding bump 421a into the rear guiding slots 115a from a lower to upper direction until the rear plate 42a can't be moved; secondly, press the bottom of the limiting bump 17 and form the supporting portion 116 received in the notches 32.

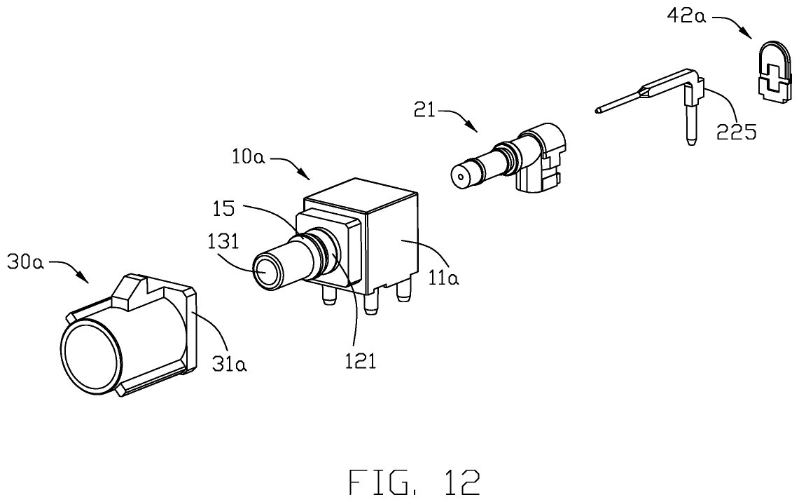

Referring to FIGS. 12-14, the vertical portion of the contact 22 has a protruding portion 225, the insulating base 21 surrounds the contact 22 tightly by injection molding. The insulating base 21 has the rear notch 214 in which the protruding portion 225 exposed. Thus, the contact 22 is fixed in the insulating base 21 firmly.

In this embodiment, the metal housing 10 with the terminal assembly 20 is assembled to the outer shell 30a. The main portion 31a of outer shell 30a is provided with plural locking arms 34 latched in the annular slot 121 of the metal housing 10. The locking arm 34 inclines inwardly and forwardly from the rear end of the circumferential wall 32 of the outer shell 30a in which the mating portion 13 is received. The metal housing 10 has a guiding face 15 which is in front of the annular groove 121 and gradually shrinks when extends forward. The outer shell 30a is assembled to the metal housing 10 with the terminal assembly 20 from the front of the metal housing 10 to the rear of it. During that, the locking arms 34 slide along the guiding face 15 and expand outward gradually until a free end of the locking arm snaps into the annular slot 121. Thus, the outer housing 30 can be fixed to the metal housing 10 firmly.

Although the present invention has been described with reference to particular embodiments, it is not to be construed as being limited thereto. Various alterations and modifications can be made to the embodiments without in any way departing from the scope or spirit of the present invention as defined in the appended claims.

1. A board connector comprising:
a metal housing comprising a base portion, a connecting portion extending forward from the base portion, and a mating portion extending forward from the connecting portion, the mating portion comprising at least one mating tube opening forward;
at least one terminal assembly retained in the metal housing and comprising an insulating base and a contact retained in the insulating base with a contacting portion extending into the corresponding mating tube and a tail portion exposed to the insulating base; and
an outer shell comprising a main portion fixed on the connecting portion and a circumferential wall extending forward from the main portion, the circumferential wall surrounding the mating portion to define a mating space therebetween;
wherein the outer shell is fixed with the metal housing by an injection molding process, and the main portion of the outer sell has an annular rib filled in an annular slot at an outside of the connecting portion.

2. The board connector as claimed in claim 1, wherein a front face of the main portion of the outer sell and a front face of the connecting portion exposed in the mating space are located in a same upright plane.

3. The board connector as claimed in claim 1, wherein four mating tubes are formed in the metal housing to receive four terminal assemblies respectively, and two upper terminal assemblies of the four terminal assemblies are located in an upper row and two lower terminal assemblies of the four terminal assemblies are located in a lower row.

4. The board connector as claimed in claim 3, wherein the base portion of the metal housing has a rear face, a bottom face, and four receiving grooves opening through the rear face and the bottom face, the four receiving grooves communicate with corresponding mating tubes respectively, the upper terminal assemblies and the lower assemblies are separated by a horizontal wall of the metal housing, and terminal assemblies located at one side of the base portion are separated from terminal assemblies located at another side of the base portion by a vertical wall of the metal housing.

5. The board connector as claimed in claim 3, comprising a middle plate and a rear plate, wherein the base portion of the metal housing has a middle guiding slot and a rear guiding slot at each side wall thereof, the middle plate is inserted into the middle guiding slot and located between the lower terminal assemblies and the upper terminal assemblies, and the rear plate is inserted into the rear guiding slot and located behind the upper terminal assemblies.

6. The board connector as claimed in claim 5, wherein a depth of the middle guiding slot is greater than that of the rear guiding slot.

7. The board connector as claimed in claim 3, wherein the insulating base of the terminal assembly has a horizontal portion and a vertical portion, and the insulating base is fixed with the contact by an injection molding process.

8. The board connector as claimed in claim 7, wherein the horizontal portion of the insulating base has a slot and the corresponding contact is partially exposed to the slot.

9. The board connector as claimed in claim 8, wherein the vertical portions of the insulating bases of the upper terminal assemblies have rear notches and side notches, the corresponding contacts are exposed to the rear notches and the side notches, the vertical portion of the insulating base of the lower terminal assemblies has rear notches, and corresponding contacts are exposed to the rear notches.

10. The board connector as claimed in claim 1, wherein the contacting portions and the tail portions of the contacts are cylindrical, and a middle portion between the contacting portion and the tail portion is plate-like.

11. A board connector comprising:
a metal housing comprising a base portion, four mating tubes opening forward, and four receiving grooves opening through a rear face and a bottom face of the base portion and communicating with corresponding mating tubes;
four terminal assemblies received and retained in corresponding receiving grooves; and
a rear plate;
wherein the base portion of the metal housing has a rear guiding slot and a supporting portion at each side wall thereof, the supporting portions extend horizontally, the rear plate slides into the rear guiding slots from the bottom face, and the supporting portions block a bottom face of the rear plate from moving downwardly.

12. The board connector as claimed in claim 11, wherein the rear plate is made from metal material.

13. The board connector as claimed in claim 11, wherein the rear plate has two notches at two ends of the bottom face thereof, and the supporting portions are located in corresponding notches.

14. The board connector as claimed in claim 11, wherein the rear guiding slot is narrower from a lower side to an upper side thereof.

15. The board connector as claimed in claim 11, wherein the rear face of the rear plate has a cross-shaped protruding rib.

16. The board connector as claimed in claim 11, wherein the rear plate has a guiding bump for the rear plate to slide in the rear guiding slots, and the guiding bump has an inverted U-shape and extends from one side to another side of the rear plate.

17. The board connector as claimed in claim 11, wherein the base portion has a limiting bump on each side wall near the bottom face thereof, and the rear guiding slot extends through the limiting bump in an upper-lower direction.

18. The board connector as claimed in claim 11, further comprising an outer shell, and wherein the metal housing has a connecting portion between the mating portion and the base portion, the connecting portion has an annular slot, and the outer shell is retained in the annular slot and surrounds the mating tubes to define a mating space.
